(19) United States
(12) Patent Application Publication
(10) Pub. No.: US 2003/0147018 A1
(43) Pub. Date: Aug. 7, 2003

(54) Display apparatus having polycrystalline semiconductor layer

(76) Inventors: Keiichi Sano, Anpachi-gun (JP); Tsutomu Yamada, Motosu-gun (JP)

Correspondence Address: Michael A. Cantor, Esq., CANTOR COLBURN LLP, 55 Griffin Road South, Bloomfield, CT, 06002, US

(21) Appl. No.: 10/353,557

(22) Filed: Jan. 29, 2003

(30) Foreign Application Priority Data
Jan. 30, 2002 (JP) 2002-21845

(51) Int. Cl. G02F 1/136

(52) U.S. Cl. 349/42

(57) ABSTRACT

A driving element corresponding to each pixel is formed in the pixel region, and a driving element for controlling the driving element in each pixel is formed in the driver region provided around the pixel region. The driving element in each of the pixel region and the driver region uses, as an active layer, a polycrystalline semiconductor layer which is formed by applying laser annealing to a single amorphous silicon layer and polycrystallizing the amorphous layer. The grain size in the polycrystalline semiconductor layer of the driving element in the pixel region is formed smaller than the grain size in the polycrystalline semiconductor layer of the driving element in the driver region, so as to realize the driving element capable of high speed operation in the driver region and the driving elements with less non-uniformity in the pixel region. Further, by selectively forming a metal layer which functions as a light shielding layer as well under the polycrystalline semiconductor layer of the driving element in the pixel region, the grain size of the polycrystalline semiconductor layer obtained in each of the pixel region and the driver region using laser annealing under the same conditions can be adjusted to an optimum size.

### BACKGROUND OF THE INVENTION

1. Field of the Invention

The present invention relates to a semiconductor display apparatus and a method of manufacturing a semiconductor display apparatus.

2. Description of Related Art

Semiconductor display apparatuses include liquid crystal display apparatuses and electroluminescence (hereinafter referred to as “EL”) display apparatuses. Of these display apparatuses, high resolution type displays, for example, often adopt a so-called active matrix type in which a driving element such as a thin film transistor (hereinafter referred to as a “TFT”) is formed corresponding to each dot which is a minimum unit for display.

An active matrix display apparatus comprises a driving element for driving a display element such as an EL element and a liquid crystal capacitor for each pixel, and a driving circuit for driving the driving element via a signal line. The driving element in each pixel is driven by the driving circuit to drive the corresponding display element.

In these semiconductor display apparatuses, polycrystalline silicon formed by aggregation of single grain silicon is often used. When the polycrystalline silicon is used in an active layer of a TFT, the performance of the TFT is significantly affected by the grain size of the polycrystalline silicon. Generally, it is believed that the larger the grain size of polycrystalline silicon used in the active layer of the driving element or the elements in the driving circuit, the more the performance of these TFTs is increased. This is because, as the grain size increases, a ratio of a grain boundary, which is an interface between grains acting as loads (traps), to carriers flowing through the element decreases in a channel of a TFT. Accordingly, various approaches have been proposed so as to increase the grain size of polycrystalline silicon, and display apparatuses using polycrystalline silicon with an increased grain size have been developed by employing these approaches.

However, these display apparatuses using a TFT formed by such polycrystalline silicon with large grain size have a problem that the performance varies among TFTs, which may further deteriorate the display quality. This problem will be described with reference to FIGS. 1A and 1B.

As shown in the upper part of FIG. 1A, when the grain size is smaller than the size of the channel region, a ratio of grain boundary is substantially the same in different channels located at different positions. This is illustrated in cases A1 and B1 in the lower part of FIG. 1A. When the grain size is large as shown in the upper part of FIG. 1B, on the other hand, a ratio of the grain boundary in each different channel varies depending on the location of each channel. More specifically, while in some cases such as the case A2 shown in the lower part of FIG. 1B, a ratio of grain boundary within a channel is very small, in other cases such as the case B2 a ratio of grain boundary in a channel is large. In this manner, when the grain size of polycrystalline silicon is large, the ratio of grain boundary within each channel of a TFT varies significantly depending on the location of the channel, which further causes a variation in the characteristics among TFTs. Such a TFT, when used for a driving element of a display apparatus, causes a variation in display, which leads to deterioration of display quality.

### SUMMARY OF THE INVENTION

The present invention has the following features and can form a driving element with excellent characteristics in each of the pixel region and the driver region.

In accordance with one aspect of the present invention, there is provided a display apparatus comprising a pixel region and a driver region on a single substrate, the pixel region including a plurality of pixels, each pixel having a display element and a pixel region driving element for driving the display element, and the driver region including a plurality of driver region driving elements which output a signal for driving each pixel in the pixel region, wherein an active layer of the pixel region driving element and an active layer of the driver region driving element are both a polycrystalline semiconductor layer, and the grain size of the polycrystalline semiconductor layer of the pixel region driving element is smaller than the grain size of the polycrystalline semiconductor layer of the driver region driving element.

Thus, the ratio of the grain boundary can be set substantially the same for all the driving elements in the pixel region, while in the driver region, the grain size of the elements can be increased to enhance the driving capability.

In accordance with another aspect of the present invention, in the above display apparatus, a buffer layer is formed between the polycrystalline semiconductor layers of the pixel region driving element and the driver region driving element, and the substrate, and in an area corresponding to an area of the pixel region driving element where the polycrystalline semiconductor layer is formed, a metal layer is further formed between the buffer layer and the substrate.

With the above configuration, when the amorphous semiconductor in both the pixel region and the driver region is polycrystallized by applying laser irradiation under the same conditions, due to the heat radiation effect by the metal layer, the grain size of the resultant polycrystalline semiconductor in the pixel region can be automatically made smaller than the grain size of the resultant polycrystalline semiconductor in the driver region where no metal layer is provided.

In another aspect of the present invention, in the above display apparatus, the metal layer is a light shielding layer which blocks ambient light entering the pixel region driving element through the substrate which is transparent.

As described above, by using the light shielding layer as the metal layer, it is possible to make the grain size of the polycrystalline semiconductor forming the driving element in the pixel region smaller than the grain size of the polycrystalline semiconductor forming the elements in the driving circuit without the need to provide an extra step. Further, in the pixel region, especially when a transparent substrate is used, there is a problem that ambient light entering the driving element through the substrate causes a leakage current, which adversely affects the display quality. By providing the light shielding layer, this problem can be eliminated by reliably preventing such ambient light from entering the driving element.

In another aspect of the present invention, in the above display apparatus, the metal layer is formed at a location which overlaps a channel region in the active layer of the pixel region driving element which is formed by a thin film transistor.

With the configuration in which the metal layer overlaps the channel region as described above, it is possible to reliably prevent ambient light from entering the channel region which suffers from generation of a leak current most seriously when receiving ambient light through the substrate.

In accordance with another aspect of the present invention, in the above display apparatus, either a constant voltage or a signal which is applied to a scanning line for scanning the corresponding pixel region driving element formed above the metal layer is applied to the metal layer.

Because the signal applied to the scanning line is periodically shifted, it is possible to prevent a change in the characteristics of the driving element formed above the light shielding layer caused by continuously applying a constant voltage to the metal layer.

In accordance with another aspect of the present invention, in the above display apparatus, a control voltage which is applied to each pixel is applied to the metal layer.

By applying a voltage which is supplied to each pixel to the metal layer, the potential of the metal layer is floating and therefore changes, so that unnecessary change in the transistor characteristics can be prevented.

In accordance with another aspect, in the above display apparatus, the metal layer has a tapered shape with an end spreading toward the substrate.

Because many layers including the driving elements in the pixel region are formed above the metal layer, cracks or the like in these layers can be reliably prevented by forming the metal layer in a tapered shape.

In accordance with another aspect of the present invention, in the above display apparatus, the buffer layer is formed of a silicon oxide layer or comprises a silicon nitride layer formed toward the substrate and a silicon oxide layer formed toward the polycrystalline semiconductor layer.

By forming the buffer layer having a multi-layer structure between the metal layer and the polycrystalline silicon layer in the pixel region or between the substrate and the polycrystalline silicon layer in the driver region, the heat capacity required for forming the polycrystalline semiconductor layer having the optimum grain size in each region can be easily adjusted taking into consideration the heat leakage by the metal layer at the time of laser annealing. Further, with the buffer layer having the multi-layer structure as described above, due to the silicon nitride layer formed toward the substrate or the metal layer, it is possible to reliably block the diffusion of impurities from the substrate and the metal layer into the polycrystalline semiconductor layer and the silicon oxide layer. Also, by forming the silicon oxide layer in contact with the polycrystalline semiconductor layer, high consistency can be secured between these layers, and carrier traps in the polycrystalline semiconductor layer which functions as an active layer can be reduced.

Further, in another aspect of the present invention, in the above display apparatus, a buffer layer is formed between the polycrystalline semiconductor layers of the pixel region driving element and the driver region driving element and the substrate, in a region corresponding to a region of the pixel region driving element where the polycrystalline semiconductor layer is formed, a metal layer is further formed between the buffer layer and the substrate, and in each of the pixel region and the driver region, the buffer layer is formed to a thickness at which a difference in heat capacity resulting from a difference in radiation amount between the pixel and driver regions due to the existence of the metal layer formed below can be held

By adjusting the buffer layer to a thickness which allows a difference of heat capacity caused by a difference in radiation amount to be held, namely a thickness at which such a difference in heat capacity is not cancelled, it is possible to easily form a polycrystalline semiconductor layer having a different grain size in each of the pixel region and the driver region using the same polycrystallization annealing, even when each region requires a different optimum grain size.

In another aspect of the present invention, there is provided a method of manufacturing a display apparatus comprising a pixel region and a driver region on a single substrate, in which the pixel region includes a plurality of pixels, each pixel having a display element and a pixel region driving element for driving the display element, and the driver region includes a plurality of driver region driving elements which output a signal for driving each pixel in the pixel region, the method comprising the steps of selectively forming a metal layer above the substrate in a region where the pixel region driving element is to be formed; forming a buffer layer so as to cover the metal layer; forming an amorphous semiconductor layer on the buffer layer; polycrystallizing the amorphous semiconductor layer by laser annealing; and forming a driving element in each of the pixel region and the driver region, the driving element using a polycrystalline semiconductor layer formed in the polycrysallization step as an active layer.

In another aspect of the present invention, in the above method of manufacturing a display apparatus, the metal layer has a tapered shape with an end spreading toward the substrate.

In another aspect of the present invention, in the above method of manufacturing a display apparatus, the buffer layer is formed by a silicon oxide layer, or formed by sequentially accumulating a silicon nitride layer and a silicon oxide layer from the substrate side in a laminate structure.

In another aspect of the present invention, in the above method of manufacturing a display apparatus, a transparent substrate is used as the substrate, and the metal layer also functions as a light shielding layer.

As described above, after the metal layer is formed in a region on the semiconductor layer corresponding to the driving element, light energy is applied to the semiconductor layer for crystallization. As a result, due to the radiation property of the metal layer, an amount of light energy used for polycrystallization is smaller in the portion of the semiconductor layer corresponding to the region where the metal layer is formed than in other regions of the semiconductor layer. The amount of light energy can be adjusted by adjusting the thickness of the buffer layer formed under the semiconductor layer. Consequently, the grain size of the polycrystalline semiconductor in the region where the metal layer is formed can also be adjusted to a desired size by adjusting the thickness of the buffer layer. It is therefore possible to obtain polycrystalline semiconductor having a desired grain size for the driving elements in the pixel region and also to make the ratio of grain boundary in each of these driving elements substantially the same for all the driving elements, while light energy is applied so as to obtain the polycrystalline semiconductor with a desired grain size for forming the elements in the driver region. Accordingly, the elements in the driver region which require high speed operation and the driving elements in the pixel region having uniform characteristics can be accomplished simultaneously.

### BRIEF DESCRIPTION OF THE DRAWINGS

These and other advantages of the invention will be explained in the description below, in connection with the accompanying drawings, in which:

FIG. 1 is a view showing a relationship between the grain size of polycrystalline silicon and a ratio of the grain boundary in a channel of a transistor;

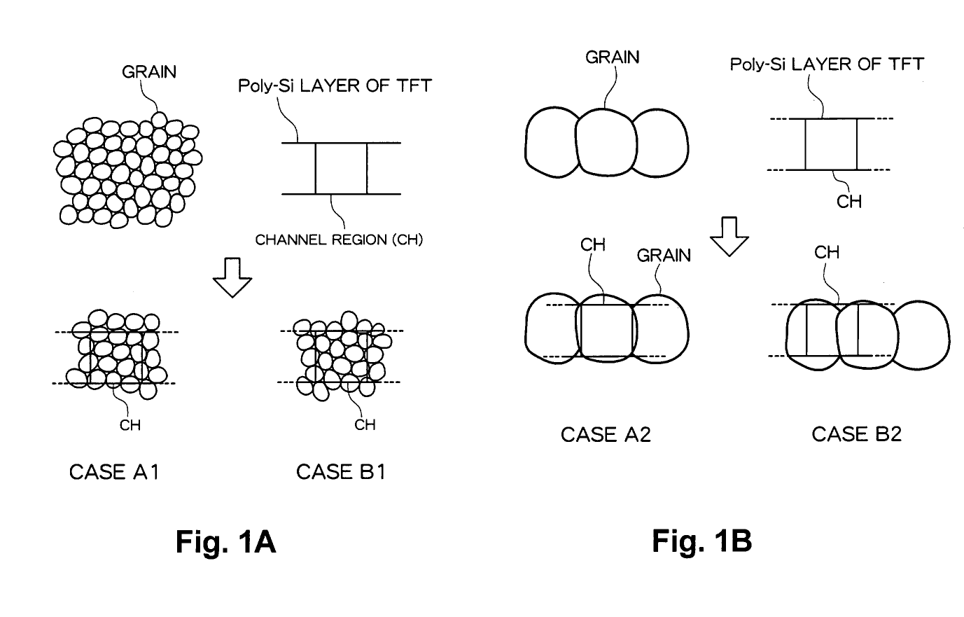

FIG. 2 is a view schematically showing a circuit configuration of a liquid crystal display apparatus according to an embodiment of the present invention;

FIG. 3 is a view schematically showing a plan configuration of a liquid crystal display apparatus according to the embodiment of the present invention;

FIG. 4 is a view showing a relationship between the thickness of an oxide silicon film formed on a glass substrate or a light shielding layer, and the grain size of resultant polycrystalline silicon;

FIGS. 5A, 5B, 5C, 5D and 5E show a process for manufacturing a liquid crystal display apparatus according to the embodiment of the present invention;

FIG. 6 is a view showing a further connection method of a light shielding layer of a liquid crystal display apparatus according to the embodiment of the present invention; and

FIG. 7 is a view schematically showing a configuration of a further display apparatus according to an embodiment of the present invention.

### DETAILED DESCRIPTION OF THE PREFERRED EMBODIMENT

A semiconductor display apparatus and a manufacturing method thereof according to the present invention will be described with regard to an embodiment which is applied to a liquid crystal display apparatus and a manufacturing method thereof, with reference to the drawings.

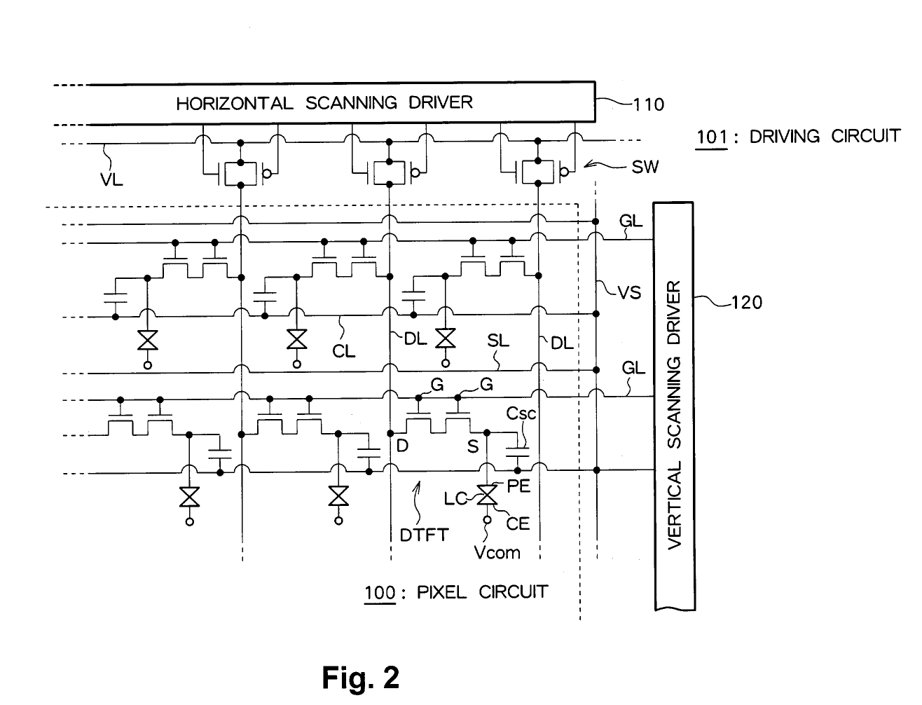

FIG. 2 shows a circuit diagram of a liquid crystal display apparatus according to the present embodiment.

Referring to FIG. 2, the liquid crystal display apparatus comprises a pixel circuit 100 formed in a pixel region and a driving circuit 101 in a driver region formed around the pixel region. The driving circuit 101 includes sampling switches SW, a horizontal scanning driver 110, and a vertical scanning driver 120. The pixel circuit 100 and the driving circuit 101 are formed on the same substrate.

The pixel circuit 100 comprises, for each pixel, liquid crystal (liquid crystal capacitor) LC which functions as a display element, between a pair of a pixel electrode PE and an opposing electrode CE. The opposing electrodes CE corresponding to the respective pixels are conducting with regard to each other and are set to the same potential (Vcom). On the other hand, each pixel electrode PE is connected to a source S of a top gate type double gate transistor DTFT and to one electrode of a storage capacitor Csc which is provided in the horizontal scanning direction. The other electrode of the storage capacitor Csc of each pixel is connected with a storage capacitor line CL provided in the horizontal scanning direction, and the storage capacitor lines CL are connected with one another via a voltage supply line VS. To the voltage supply line VS, a light shielding layer line SL provided under the channel of the double gate transistor DTFT is connected.

For the double gate transistor DTFT provided in each pixel, a data line (drain signal line) DL provided along the vertical scanning direction is connected to a drain D, and a scanning line (gate signal line) GL provided along the horizontal scanning direction is connected to a gate G. By selectively applying a data signal and a scanning signal to the data signal line DL and the gate signal line GL by the drivers 110 and 120, a specific transistor TFT is driven.

More specifically, a sampling switch SW formed by a CMOS transmission gate is connected to the data signal line DL. When pulse signals having inverted logical values are applied from the horizontal scanning driver 110 to the respective gates of a p-ch transistor and an n-ch transistor of a specific switch SW, a specific data signal line DL is selected. Further, a video signal, which is a luminance signal, is sequentially applied to a video signal line VL connected to the switches SW. Thus, a video data signal for each pixel is output to the data signal line DL selected by the switch SW and then applied to the drain D of each transistor DTFT connected to the data signal line DL.

On the other hand, the vertical scanning driver 120 outputs a selection (scanning) signal to a specific gate signal line GL which is sequentially selected. As a result, the transistor DTFT connected to the selected gate signal line GL is turned on, and a video data signal applied to the data signal line DL which is connected to the transistor DTFT which is turned on is applied to the pixel electrode PE through the drain-source of that transistor DTFT. Further, a charge in accordance with the video data signal is accumulated in the storage capacitor which is connected to the source and the pixel electrode PE.

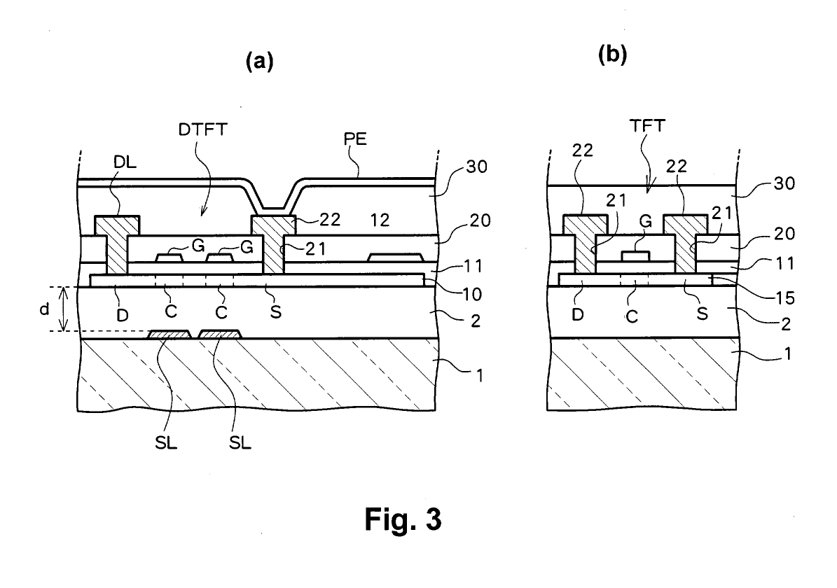

Referring to FIG. 3, the sectional configuration of the liquid crystal display apparatus having the above configuration will be described. Here, FIG. 3(a) shows a sectional configuration of the transistor DTFT and near the pixel electrode PE within the pixel circuit 100 of the liquid crystal display apparatus, and FIG. 3(b) shows a sectional configuration of the horizontal and vertical scanning drivers 110 and 120 and the transistor forming the switch SW.

As shown in FIG. 3(a), on a glass substrate 1, a light shielding layer line SL made of a metal such as chromium (Cr), molybdenum (Mo), titanium (Ti) or tungsten (W), having a thickness of 200 nm, for example, is formed to have tapered side walls. Then, a buffer layer 2 formed by silicon oxide (SiO₂) is formed so as to cover the light shielding layer line SL and the glass substrate 1 for planarizing the whole regions with and without the light shielding layer lines being formed therein. The buffer layer 2 is formed to a thickness between 50 nm and 1000 nm, for example, and preferably between 100 nm and 300 nm. On the top surface of this buffer layer 2, polycrystalline silicon 10 having a thickness of 50 nm, for example, is formed. The polycrystalline silicon 10, when impurities are doped therein, is made conductive, and the source S, channel C, and drain D of the transistor DTFT as described above are formed therein. On the polycrystalline silicon 10, an insulating film 11 made of silicon oxide (SiO₂) and constituting a gate insulating film of the above-described transistor DTFT is formed to have a thickness of 100 nm, for example. Then, the gate of the transistor DTFT, which is formed of a metal such as Mo, Ti, and W, is formed thereon to a thickness of, for example, 200 nm.

The light shielding layer line SL is formed along the gate of the transistor and the gate signal line GL so as to cover the region below the gate and the gate signal line GL in the normal direction. Thus, the light shielding layer line SL prevents light from entering the channel C through the glass substrate 1.

Further, on the polycrystalline silicon 10 and the insulating film 11, the other electrode 12 of the storage capacitor C is formed of the same metal as that of the gate G. Then, on the insulating film 11, the gate G and the electrode 12, an inter-layer insulating film 20 formed by sequentially accumulating a silicon nitride film having a thickness of, for example, 100 nm, and a silicon oxide film of 500 nm, for example, is formed. A contact hole 21 is formed in this inter-layer insulating film 20. On the inter-layer insulating film 20, the data signal line DL and the electrode 22, each formed by sequentially accumulating, from within the contact hole 21, Mo, Aluminum (Al), Mo having a thickness of 100 nm, 400 nm, and 100 nm, respectively, are formed. Further, a planarization insulating film 30 is formed covering the inter-layer insulating film 20, the data signal line DL, and the electrode 22. On the planarization insulating film 30, the above-described pixel electrode PE made of ITO (Indium Tin Oxide) is formed to a thickness of 85 nm, for example, and is connected to the electrode 22 via a contact hole formed in the planarization insulating film 30.

On the other hand, the TFT portion of the transistor forming each of the horizontal scanning driver 110, the vertical scanning driver 120 and the switch SW is also formed on the buffer layer 2 which is formed on the glass substrate 1 in a manner similar to the pixel region, except that no light shielding layer line SL is formed on the substrate, as shown in FIG. 3(b). More specifically, a drain D, channel C and source S are formed in polycrystalline silicon 15 formed on the buffer layer 2, when impurities are doped in the polycrystalline silicon 15, for example. On the polycrystalline silicon 15 having the drain D, channel C and source thus formed therein, the insulating film 11 formed by silicon oxide and constituting a gate insulating film is formed. Then, a gate G formed by the same material as the gate G of the double gate transistor DTFT is formed on the insulating film 11. On the region above the insulating film 11 and the gate G, the inter-layer insulating film 20, the contact hole 21 and the electrode 22 are formed in the same manner as the pixel region described above.

As described above, the TFTs formed of the same materials are formed in both the pixel region and the driver region. More specifically, the TFTs in either regions adopt the polycrystalline silicon layers 10 and 15 as the active layer. Further, according to the present embodiment, the grain size of the polycrystalline silicon 10 forming the double gate transistor DTFT provided in the pixel region is set to be smaller than the grain size of the polycrystalline silicon 15 forming the transistor TFT such as in the horizontal scanning driver 110 or the like. More specifically, the grain size of the polycrystalline silicon in the channel region C and in the region near the channel of the transistor DTFT in the pixel region is set to be sufficiently smaller than the size of the channel C of the transistor DTFT in the pixel region.

With the setting of the grain size as described above, appropriate characteristics can be imparted to each of the transistor DTFT of the pixel circuit 100 and the transistor TFT of the driving circuit 101 such as the horizontal scanning driver 110.

Specifically, for the transistor DTFT of the pixel circuit 100, variation of the characteristics among transistors resulting from variation of the ratio of grain boundary within a channel C significantly affects the display quality. This is regarded as a result of a variation of noise signals caused when a gate signal of the transistor DTFT is turned off so as to determine a video data signal (display signal). Accordingly, the grain size of the polycrystalline silicon used for the active layer of the transistor DTFT in the pixel circuit is set to be sufficiently smaller than the channel width and the channel length of the transistor DTFT, so that the ratio of grain boundary within the channel C of the transistor DTFT in each pixel is made substantially the same for all the pixels.

For the transistor TFT of the driving circuit 101, on the other hand, the display quality is not much affected even when the grain size of the polycrystalline silicon of the active layer is increased to a certain degree. This is considered because the channel width of the transistor TFT of the driving circuit 101 is set larger than the channel width of the transistor DTFT, thereby averaging the variation of the transistor characteristics. Further, even if the characteristics of the transistor vary in the driving circuit, this would only change the timing for a driving pulse and does not directly affect the display signal, contrary to the pixel driving element. Accordingly, the grain size of the polycrystalline silicon forming the transistor TFT of the driving circuit 101 is set somewhat large in order to secure the driving capability (high speed operation capability).

According to the present embodiment, in order to optimize the characteristics of the transistor DTFT of the pixel circuit 100 and the transistor TFT of the driving circuit 101, respectively, the light shielding layer line SL is used in forming the polycrystalline silicon 10 and 15 by the same laser irradiation step. The light shielding layer line SL, which is made of a metal, as described above, has a discharge effect. Therefore, when laser is applied to a single amorphous silicon for polycrystallization, the portion of the amorphous silicon having the light shielding layer line SL formed thereunder has a smaller energy utilized for the polycrystallization than the remaining portions, and therefore has a smaller grain size for the resultant silicon. Thus, by adjusting the thickness of the buffer layer 2 (indicated by “d” in FIG. 3) provided between the light shielding layer line SL and the amorphous silicon, it is possible to adjust the degree of discharge effected by the light shielding layer line SL at the time of laser irradiation, and to therefore adjust the size of grains located above the light shielding layer line SL.

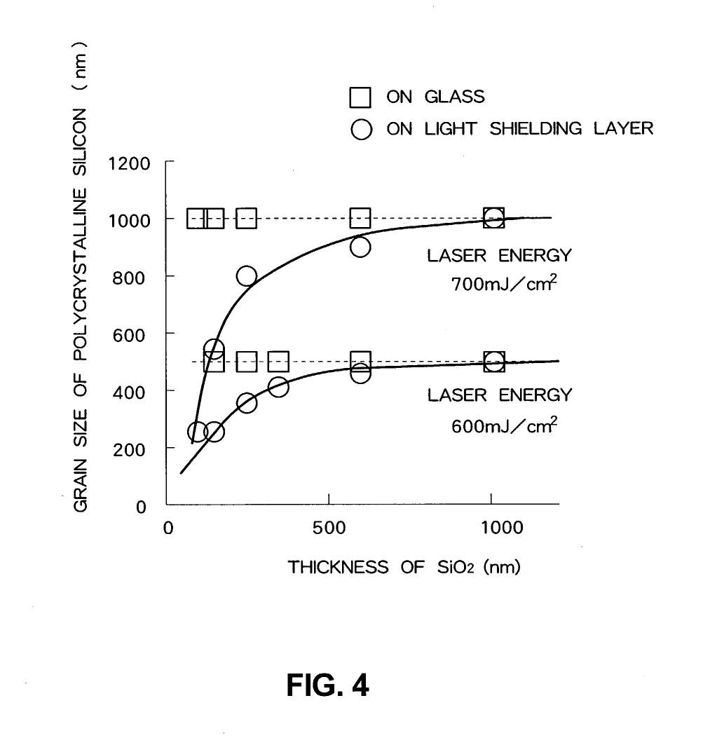

FIG. 4 shows a relationship between the thickness of the silicon oxide film between the amorphous silicon and the light shielding layer and between the amorphous silicon and the glass substrate, and the grain size when the amorphous silicon is polycrystallized using laser irradiation.

As shown in FIG. 4, when amorphous silicon is formed on the accumulated layers of the glass substrate and the silicon oxide layer, the grain size of the polycrystalline silicon formed by applying a constant laser energy to the amorphous silicon is not affected by the thickness of the silicon oxide layer. (In FIG. 4, the dotted line shows expected values and squares indicate values actually measured.)

When the amorphous silicon is formed on the accumulated layers of the light shielding layer and the silicon oxide layer, on the other hand, the grain size of the polycrystalline silicon formed by applying constant laser energy to the amorphous silicon changes depending on the thickness of the silicon oxide layer. (In FIG. 4, the solid line shows expected values and blank circles indicate values actually measured.) This is considered because the greater the thickness of the silicon oxide layer the greater the distance between the light shielding layer and the amorphous silicon, and the lower the discharge effect by the light shielding layer at the time of laser irradiation.

In this manner, by adjusting the thickness of the silicon oxide serving as a buffer layer which is provided between the light shielding layer and the amorphous silicon, it is possible to adjust the grain size of the polycrystalline silicon generated by the laser irradiation. Therefore, when the laser energy to be applied and the thickness of the silicon oxide between the light shielding layer and the amorphous silicon are used as parameters, it is possible to generate polycrystalline silicon having a different grain size in each of the portion having the light shielding layer formed thereunder and other portions. For example, in order to obtain the grain size of 250 nm for the polycrystalline silicon 10 forming the transistor DTFT and the grain size of 1000 nm for the polycrystalline silicon 15 forming the transistor TFT of the driving circuit, it is possible to set the laser energy to 700 mJ/cm² and the oxide silicon thickness to 100 nm, for example.

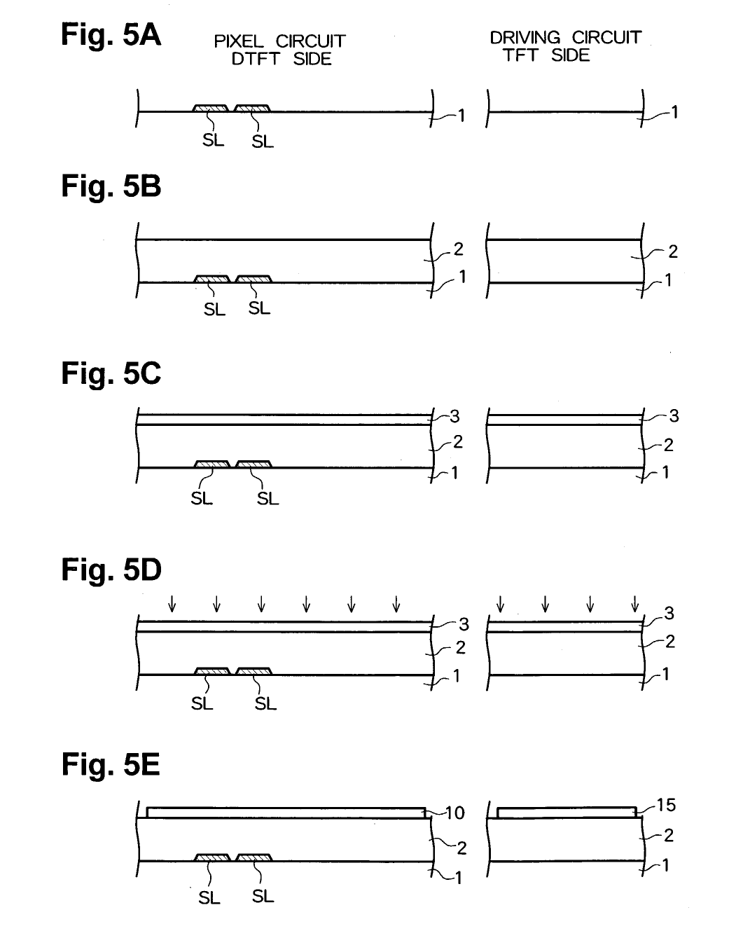

Referring to FIGS. 5A to 5E, steps of manufacturing the liquid crystal display apparatus according to the present embodiment will be described. In the manufacturing steps shown herein, the transistor DTFT in the pixel region and the transistor TFT of the driving circuit are manufactured in the same step.

In the series of steps, first, as shown in FIG. 5A, a refractory metal film is formed by sputtering at a location on the glass substrate where the transistor DTFT (channel C) is to be formed, and the refractory metal film is then patterned to form the light shielding layer line SL.

Then, as shown in FIG. 5B, a silicon oxide film is formed using plasma CVD on the glass substrate 1 and the light shielding layer line SL, to form a buffer layer 2. Here, the buffer layer 2 may be formed by sequentially accumulating a silicon nitride layer and a silicon oxide layer in this order in a laminate structure from the glass substrate side.

When a silicon nitride layer and a silicon oxide layer are sequentially formed from the glass substrate side (from the light shielding layer side in the pixel region) to form the buffer layer 2, as described above, and the amorphous silicon layer 3 for forming the polycrystalline silicon layers 10, 15 is then formed on the silicon oxide film, it is possible to reliably block impurities entering the amorphous silicon layer 3 through the substrate or the light shielding layer by means of the silicon nitride layer at the time of laser annealing of the amorphous silicon layer 3 which will be described below. Further, by forming the amorphous silicon layer in contact with the silicon oxide layer, it is possible to prevent generation of a carrier trap level or the like in the active layer, when the amorphous silicon layer 3 is polycrystallized to form the polycrystalline silicon layers 10 and 15 and used as the active layer of the TFT. It is preferable to adjust the thickness of the silicon nitride layer and the silicon oxide layer in order to generate polycrystalline silicon having a grain size appropriate for each of the pixel region and the driver region by applying laser annealing with the same energy strength for both regions. For example, it is preferable that the thickness of the silicon oxide layer is 200 nm or more when the thickness of the silicon nitride layer functioning as a blocking layer is 50 nm. Alternatively, it is preferable that thickness of the silicon nitride layer is 100 nm or more when the thickness of the silicon oxide layer is 130 nm.

After formation of the buffer layer 2, the plasma CVD is continuously applied to form the amorphous silicon, as shown in FIG. 5C. Namely, a process from the formation of the buffer layer 2 through the formation of the amorphous silicon 3 is performed by a continuous film formation process. Here, the continuous film formation refers to a process in which a series of film forming steps are performed within a space which is blocked from ambient air using a multi-chamber system or the like.

Then, as shown in FIG. 5D, the amorphous silicon layer 3 is subjected to laser annealing to form polycrystalline silicon. By patterning the polycrystalline silicon which is thus formed, the polycrystalline silicon 10 for forming the transistor DTFT in the pixel region and the polycrystalline silicon 15 for forming the transistor TFT of the driving circuit are formed, as shown in FIG. 5E.

After formation of the polycrystalline silicon 10 and the polycrystalline silicon 15 having different grain sizes, the transistors DTFT and TFT or the like are formed using a well known process to complete a liquid crystal display apparatus having the configuration as shown in FIG. 3.

According to the present embodiment described above, the following advantages can be obtained.

(i) The grain size of the polycrystalline silicon 10 forming the transistor DTFT which functions as a driving element in the pixel region is set smaller than the grain size of the polycrystalline silicon 15 forming the transistor TFT as an element within the driving circuit. As a result, it is possible to preferably reduce variation of the characteristics of the transistor DTFT corresponding to each pixel, and simultaneously secure the driving capability of the transistor TFT within the driving circuit. Thus, optimization of these transistors DTFT and TFT can be achieved.

(ii) The light shielding layer line SL is only provided under the polycrystalline silicon 10 in the pixel region. As a result, when the amorphous silicon to be formed into the polycrystalline silicon 10 and 15 is formed in the same step and is then subjected to laser application under the same conditions, it is possible to make the grain size of the polycrystalline silicon 10 smaller than the grain size of the polycrystalline silicon 15.

When implementing the above embodiment, the following changes may be made.

Specifically, the materials used for the light shielding layer line SL, the buffer layer 2, the gate G, the electrode 22 or the like are not limited to those described in the above embodiment. Also, the glass substrate 1 may be replaced by an arbitrary transparent substrate such as a plastic substrate.

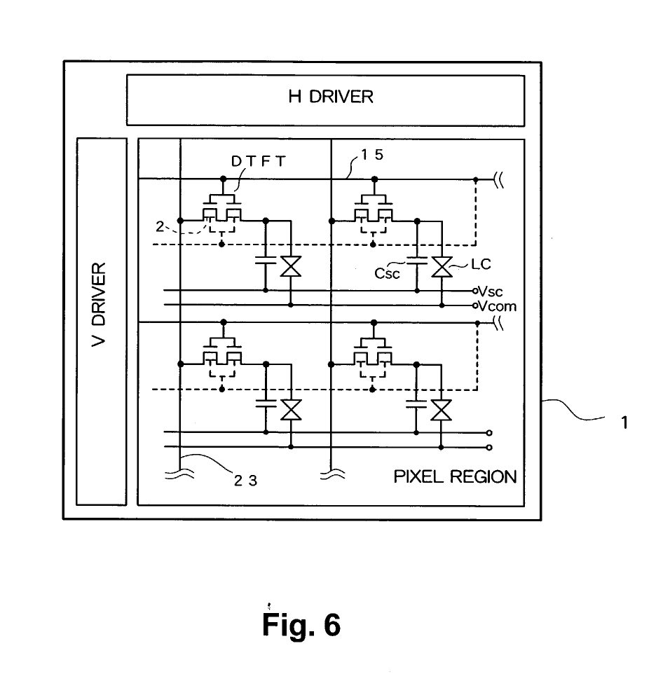

In the above embodiment, as an example in which a constant voltage is applied to the light shielding layer, the light shielding layer is connected to the storage capacitor line (electrode) and Vsc is applied to the light shielding layer, as one of the control voltages applied to each pixel. Alternatively, the light shielding layer may be connected to the common electrode which faces the pixel electrode having liquid crystal interposed between them, so that a common electrode voltage Vcom is applied to the light shielding layer. Further, a voltage which periodically changes, rather than a constant voltage, may be applied to the light shielding layer. For example, the light shielding layer may be connected to the gate GL of the TFT each formed above the light shielding layer, as shown in FIG. 6.

When the light shielding layer is not in a connected state, the potential of the light shielding layer is unstable, and an operation for charging and holding a pixel signal performed by the transistor provided above the light shielding layer is also unstable, thereby lowering display quality. By making the potential of the light shielding layer constant, such a signal charging and holding operation of the transistor becomes stable and deterioration of display quality can be prevented.

Further, when the light shielding layer is connected to the scanning line so that the voltage of the light shielding layer equals to that of the scanning signal, the capability of the transistor which is formed above the light shielding layer at the time of charging can be increased. It is therefore possible to achieve high speed driving which requires such charging capability while maintaining the effect of reducing a variation of transistor characteristics obtained by decreasing the grain size.

While in the above embodiment, the present invention is applied to a liquid crystal display apparatus using liquid crystal as a display element, the present invention is not limited to this example and is also applicable to an arbitrary semiconductor display apparatus such as an EL display apparatus which uses an EL element as a display element.

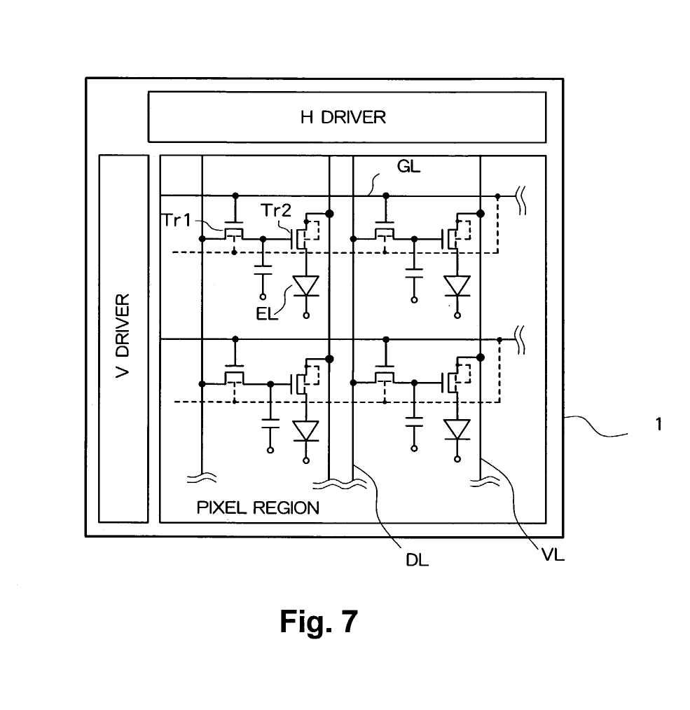

More specifically, the present invention is also applicable to an active matrix type electroluminescence display apparatus or the like as shown in FIG. 7 and can provide similar advantages. The following configuration can be employed in the EL display apparatus shown in FIG. 7. Specifically, in the horizontal (H) and vertical (V) driver regions, the light shielding layer is not formed under the TFT as in the above embodiment, and the active layer (polycrystalline silicon layer) of the TFT is formed on a laminate structure formed by a blocking layer and an insulating layer, whereas in the pixel region, the light shielding layer is formed under the TFT (Tr1, Tr2) and the above-described blocking layer and the insulating layer are formed between the light shielding layer and the active layer (polycrystalline silicon layer) of the TFT. The EL element (OLED) connected to the pixel TFT (Tr2) may have a configuration in which, on a first electrode which is, for example, the pixel electrode PE formed by ITO as shown in FIG. 3(a), a second electrode formed by an organic emissive element layer having a multi-layer or single-layer structure and a metal layer opposing the first electrode is laminated. In FIG. 7, VL indicates a power source line for supplying a current corresponding to the display data to the EL element via Tr2 of the pixel TFTs.

In FIG. 7, the metal layer under Tr1 is connected to a gate potential (G) and the metal layer under Tr2 is connected to the electroluminescece power source potential (VL) which is substantially constant. The connection in Tr2 has an effect of reducing the current capability of Tr2.

Connection of the metal layers for Tr1 and Tr2 is not limited to the above example. When high speed driving or the like is not necessary as described above, the metal layer can be connected to a constant voltage potential such as the storage capacitor line. When a greater current capability is required, a gate voltage can be applied to the metal layer. Other combinations of voltages applied to the metal layer under Tr1 and the metal layer under Tr2 are listed in the table below. In this table, G indicates a gate voltage, VL indicates an EL power source voltage, and Vsc indicates a capacitor line voltage.

TABLE

| | Tr 1 | Tr 2 | Tr 1 | Tr 2 | Tr 1 | Tr 2 |
|---|---|---|---|---|---|---|
| APPLIED | G | G | Vsc | G | VL | G |
| VOLTAGE | G | VL | Vsc | VL | VL | VL |
| | G | Vsc | Vsc | Vsc | VL | Vsc |

In the above EL display apparatus, in order to make the grain size of the polycrystalline silicon forming the active layer of the transistor in the pixel region smaller than the grain size of the polycrystalline silicon forming the active layer of the transistor in the driver region, an appropriate metal layer may be used with or without light shielding function. Specifically, the grain size of the polycrystalline silicon can be adjusted to be smaller in the pixel region than in the driver region by previously forming a metal layer with high heat radiation characteristics under the amorphous silicon layer to be formed into the active layer of the transistor in the pixel region and then subjecting the amorphous silicon layer to laser irradiation.

The present invention is also applicable to a semiconductor display apparatus in which an appropriate polycrystalline semiconductor other than polycrystalline silicon is used for forming a driving element. In this case, the grain size may be adjusted by applying light energy irradiation to the semiconductor layer.

While the preferred embodiment of the present invention has been described using specific terms, such description is for illustrative purposes only, and it is to be understood that changes and variations may be made without departing from the spirit or scope of the appended claims.

What is claimed is:

1. A display apparatus comprising a pixel region and a driver region on a single substrate,
the pixel region including a plurality of pixels, each pixel having a display element and a pixel region driving element for driving the display element, and
the driver region including a plurality of driver region driving elements for outputting a signal for driving each pixel in the pixel region,
wherein an active layer of the pixel region driving element and an active layer of the driver region driving element are both a polycrystalline semiconductor layer, and the grain size of the polycrystalline semiconductor layer of the pixel region driving element is smaller than the grain size of the polycrystalline semiconductor layer of the driver region driving element.

2. A display apparatus according to claim 1, wherein
a buffer layer is formed between the polycrystalline semiconductor layers of the pixel region driving element and the driver region driving element, and the substrate, and
in an area corresponding to an area of the pixel region driving element where the polycrystalline semiconductor layer is formed, a metal layer is further formed between the buffer layer and the substrate.

3. A display apparatus according to claim 2, wherein
the metal layer is a light shielding layer which blocks ambient light entering the pixel region driving element through the substrate which is transparent.

4. A display apparatus according to claim 2, wherein
the metal layer is formed at a location which overlaps a channel region in an active layer of the pixel region driving element which is formed by a thin film transistor.

5. A display apparatus according to claim 2, wherein
either a constant voltage or a signal which is applied to a scanning line for scanning the corresponding pixel region driving element formed above the metal layer is applied to the metal layer.

6. A display apparatus according to claim 2, wherein
a control voltage which is applied to each pixel is applied to the metal layer.

7. A display apparatus according to claim 1, wherein
the metal layer has a tapered shape with an end spreading toward the substrate.

8. A display apparatus according to claim 1, wherein
the buffer layer is formed by a silicon oxide layer.

9. A display apparatus according to claim 1, wherein
the buffer layer comprises a silicon nitride layer formed toward the substrate and a silicon oxide layer formed toward the polycrystalline semiconductor layer.

10. A display apparatus according to claim 1, wherein
a buffer layer is formed between the polycrystalline semiconductor layers of the pixel region driving element and the driver region driving element and the substrate,
in an area corresponding to an area of the pixel region driving element where the polycrystalline semiconductor layer is formed, a metal layer is further formed between the buffer layer and the substrate, and
in each of the pixel region and the driver region, the buffer layer is formed to a thickness at which a difference in heat capacity resulting from a difference in discharge amount between the pixel and driver regions due to the existence of the metal layer formed below can be maintained.

11. A method of manufacturing a display apparatus comprising a pixel region and a driver region on a single substrate, in which the pixel region includes a plurality of pixels, each pixel having a display element and a pixel region driving element for driving the display element, and the driver region includes a plurality of driver region driving elements which output a signal for driving each pixel in the pixel region, the method comprising the steps of:
selectively forming a metal layer above the substrate in a region where the pixel region driving element is to be formed;
forming a buffer layer so as to cover the metal layer;
forming an amorphous semiconductor layer on the buffer layer;
polycrystallizing the amorphous semiconductor layer by laser annealing; and
forming a driving element in each of the pixel region and the driver region, the driving element using a polycrystalline semiconductor layer formed in the polycrysallization step as an active layer.

12. A method of manufacturing a display apparatus according to claim 11, wherein
the metal layer has a tapered shape with an end spreading toward the substrate.

13. A method of manufacturing a display apparatus according to claim 11, wherein
the buffer layer is formed by a silicon oxide layer.

14. A method of manufacturing a display apparatus according to claim 11, wherein
the buffer layer is formed by sequentially accumulating a silicon nitride layer and a silicon oxide layer from the substrate side in a laminate structure.

15. A method of manufacturing a display apparatus according to claim 11, wherein
a transparent substrate is used as the substrate, and the metal layer also functions as a light shielding layer.
